(19) United States
(12) Patent Application Publication
(10) Pub. No.: US 2003/0031379 A1
(43) Pub. Date: Feb. 13, 2003

(54) Image processing apparatus and method therefor

(76) Inventor: Tsuyoshi Kondo, Fukuoka (JP)

Correspondence Address: RATNERPRESTIA, P O BOX 980, VALLEY FORGE, PA, 19482-0980, US

(21) Appl. No.: 10/215,581

(22) Filed: Aug. 9, 2002

(30) Foreign Application Priority Data
Aug. 9, 2001 (JP) 2001-242897

(51) Int. Cl. G06K 9/36

(52) U.S. Cl. 382/276

(57) ABSTRACT

The image processing apparatus disclosed in the invention has a configuration to provide offset value setting in units of a plurality of pixels and to generate offset output image in the per-unit offset data generator.

### FIELD OF THE INVENTION

The present invention relates to an image processing apparatus and method to have an output image data from input image data with offset arrangement.

### BACKGROUND OF THE INVENTION

FIG. 10 shows a block diagram of configuration for conventional image processing apparatus, FIG. 12 shows example 1 of offset pixel setting, and FIG. 13 shows example 2 of offset pixel setting.

A conventional image processing apparatus and method to have an output image data from input image data with offset arrangement is described with reference to FIG. 10 through FIG. 13.

In FIG. 10, conventional image processing apparatus 20 includes per-pixel offset data generator 21, offset pixel setup section 22 and output pixel width setup section 23. FIG. 12 and FIG. 13 show setup data provided by offset pixel setup section 22 and output pixel width setup section 23.

In addition, output image data has pixel width 24, while input image data has pixel width 25 or pixel width 29. FIG. 12 shows a case when pixel width 25 of input image data is larger than pixel width 24 for output image data. Input image data has a value of pixel width 25.

Per-pixel offset data generator 21 deletes a portion of pixel widths of input image data shown as:

offset pixel plus width 26 in left-hand side, and

offset pixel plus width 27 in right-hand side,

both provided by offset pixel setup section 22 (Hereafter, plus width is referred to as offset input image data to be deleted and minus width is referred to as offset input image data to be added with white data).

Next, output of image data having pixel width 28 provided by output pixel width setup section 23 generates pixel width 24 for output image data.

FIG. 13 shows a case when pixel width 29 of input image data is smaller than pixel width 24 for output image data. Input image data has a value of pixel width 29.

Per-pixel offset data generator 21 adds white data to pixel widths of input image data shown as:

pixel minus width 30 in left-hand side and

pixel minus width 31 in right-hand side,

both provided by offset pixel setup section 22.

Next, output of image data having pixel width 32 provided by output pixel width generator 23 generates pixel width 24 for output image data.

FIG. 11 shows a flowchart of a conventional offset data generator.

First, per-pixel offset data setup section 21 skips pixels of input image data by a number of left-hand side offset pixel plus width provided by offset pixel setup section 22 (step 200).

Next, white data are generated by a number of left-hand side offset pixel minus width provided by offset pixel setup section 22 (step 201).

Next, image data is output by a number of pixel width provided by output pixel width setup section 23 (step 202).

Moreover, white data are generated by a number of right-hand side pixel minus width provided by offset pixel setup section 22 (step 203).

Finally, pixels of input image data are skipped by a number of right-hand side offset pixel plus width provided by offset pixel setup section 22 (step 204).

As mentioned above, each line of input image data is processed to generate output image data. A conventional image processing apparatus and method, therefore, can hardly perform a speedy processing, since offset image is generated in per-pixel data processing.

### SUMMARY OF THE INVENTION

An image processing apparatus disclosed in the invention comprises:

(a) an offset unit setup section to set up right and left side offset width per-unit of a plurality of image pixels corresponding input image data;

(b) an output unit width setup section to set up output image width per-unit of a plurality of image pixels; and

(c) a per-unit offset data generator to generate an output image using

an output of the offset unit setup section;

output of the output unit width setup section; and

input image data.

### BRIEF DESCRIPTION OF THE DRAWING

FIG. 1 is a block diagram for image processing apparatus used in a first preferred embodiment of the present invention.

FIG. 2 is a schematic view of example 1 of a unit offset setting used in the first preferred embodiment of the present invention.

FIG. 3 is a schematic view of example 2 of a unit offset setting used in the first preferred embodiment of the present invention.

FIG. 4 is a schematic view of a pixel used in the first preferred embodiment of the present invention.

FIG. 5 is a configuration view of a unit used in the first preferred embodiment of the present invention.

FIG. 6 is a flowchart of a per-unit offset data generator used in the first preferred embodiment of the present invention.

FIG. 7 is a block diagram for image processing apparatus used in a second preferred embodiment of the present invention.

FIG. 8 is a flowchart of an image processing method used in the second preferred embodiment of the present invention.

FIG. 9 is a schematic view of a masking part of a unit.

FIG. 10 is a block diagram of a conventional image processing apparatus.

FIG. 11 is a flowchart of an offset data generator of a conventional image processing apparatus.

FIG. 12 is a schematic view of example 1 of a pixel offset setting of a conventional image processing apparatus.

FIG. 13 is a schematic view of example 2 of a pixel offset setting of a conventional image processing apparatus.

### DESCRIPTION OF THE PREFERRED EMBODIMENTS

The present invention is described by following preferred embodiments with reference to drawings.

First Preferred Embodiment

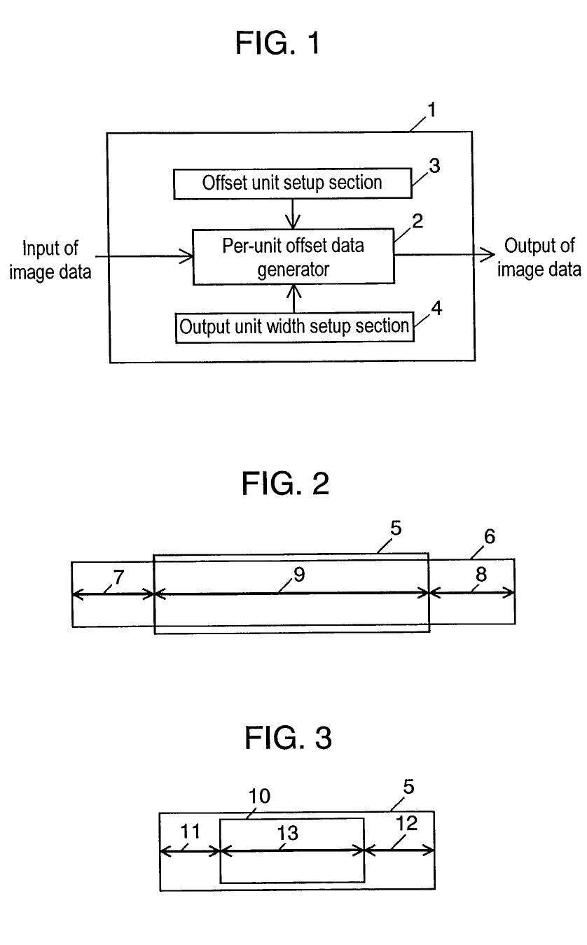

The present invention is described by following first preferred embodiment with reference to FIG. 1 through FIG. 6.

FIG. 1 shows a block diagram of an image processing apparatus used in the first preferred embodiment of the present invention. FIG. 2 is a schematic view of example 1, and FIG. 3 is a schematic view of example 2 of a unit offset setting.

In FIG. 1, image processing apparatus 1 disclosed in the first preferred embodiment of the present invention includes:

per-unit offset data generator 2;

offset unit setup section 3; and

output unit width setup section 4.

FIG. 2 and FIG. 3 show setup data provided by offset unit setup section 3 and output unit width setup section 4. In addition, output image data has unit width 5, while input image data has unit width 6 or unit width 10.

FIG. 2 shows a case when unit width 6 of input image data is larger than unit width 5 for output image data. Input image data has a value of unit width 6.

Per-unit offset data generator 2 deletes a portion of unit widths of input image data shown as:

offset unit plus width 7 in left-hand side, and

offset unit plus width 8 in right-hand side,

both provided by offset unit setup section 3.

Next, output of image data having unit width 9 provided by output unit width setup section 4 generates unit width 5 for output image data.

FIG. 3 shows a case when unit width 10 of input image data is smaller than unit width 5 for output image data. Input image data has a value of unit width 10.

Per-unit offset data generator 2 adds white data to unit widths of input image date shown as:

unit minus width 11 in left-hand side, and

unit minus width 12 in right-hand side,

both provided by offset unit setup section 3.

Therefore, output of image data having unit width 13, provided by output unit width setup section 4, generates unit width 5 for output image data.

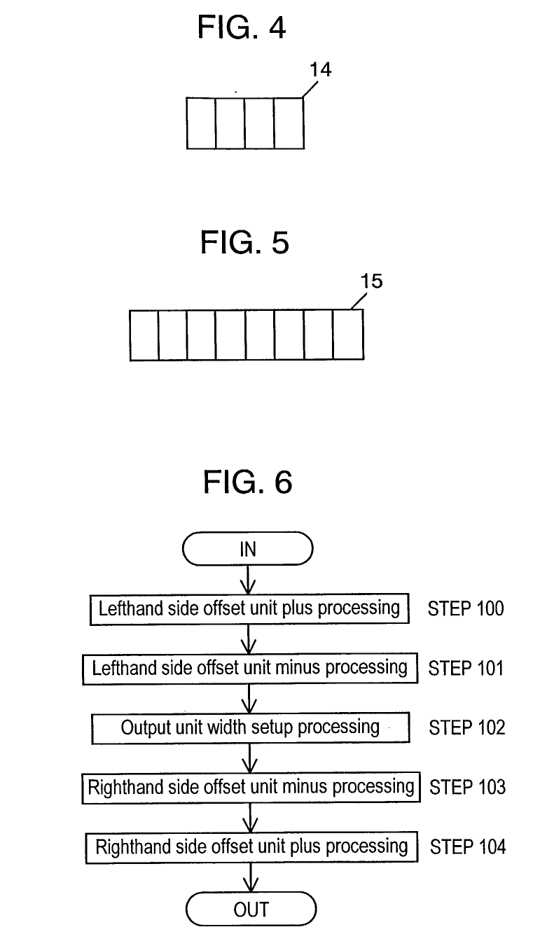

FIG. 4 shows a configuration of pixel 14, having 4 bits data. FIG. 5 shows a configuration of unit 15 consisted of 2 pixel 14, having 8 bits data. An image data is output as a parallel data of bit width of unit 15.

FIG. 6 shows a flowchart of a per-unit offset data generator.

First, per-unit offset data generator 2 skips units of image data by a number of left-hand side offset unit plus width provided by offset unit setup section 3 (step 100).

Next, white data are generated by a number of left-hand side offset unit minus width provided by offset unit setup section 3 (step 101).

Next, image data is output by number of unit width provided by output unit width setup section 4 (step 102).

Moreover, white data are generated by a number of right-hand side unit minus width provided by offset unit setup section 3 (step 103).

Finally, units of input image data are skipped by a number of right hand side offset unit plus width provided by offset unit setup section 3 (step 104).

The image processing using apparatus disclosed in the first preferred embodiment of the present invention is carried out as mentioned above.

Second Preferred Embodiment

The present invention is described by following second preferred embodiment with reference to FIG. 2 through FIG. 9.

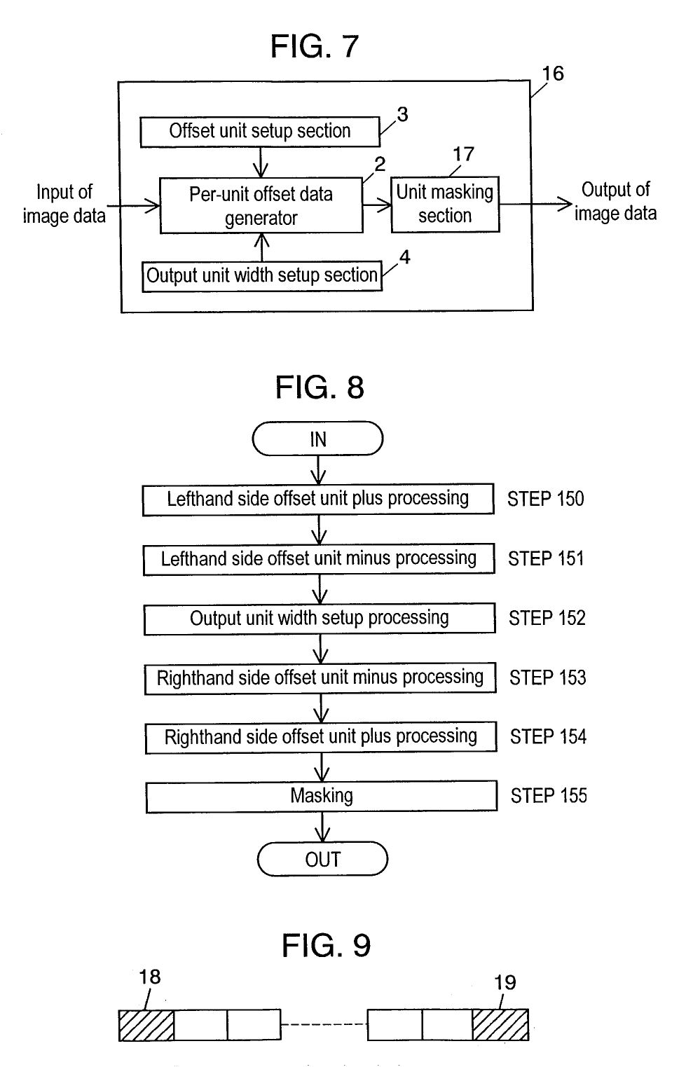

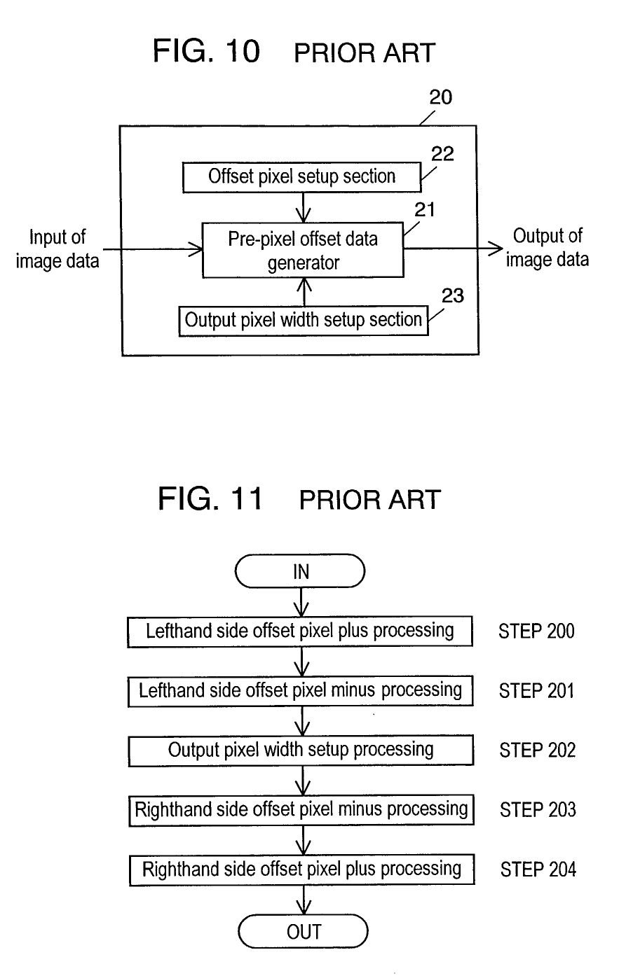

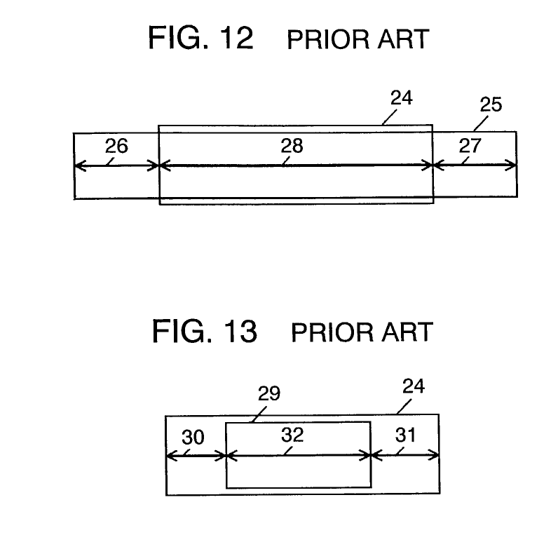

FIG. 7 shows a block diagram of an image processing apparatus used in the second preferred embodiment of the present invention.

In FIG. 7, image processing apparatus 16 used in the second preferred embodiment of the present invention includes

per-unit offset data generator 2,

offset unit setup section 3,

output unit width setup section 4, and

unit masking section 17.

FIG. 2 and FIG. 3 show form of data provided by offset unit setup section 3 and output unit width setup section 4.

In addition, output image data has unit width 5 and input image data has unit width 6 and unit width 10.

FIG. 2 shows a case when unit width 6 of input image data is larger than unit width 5 for output image data. Input image data has a value of unit width 6.

Per-unit offset data generator 2 deletes a portion of unit widths of input image data shown as:

offset unit plus width 7 in left-hand side and

offset unit plus width 8 in right-hand side

both provided by offset unit setup section 3.

Next, output of image data having unit width 9 provided by output unit width setup section 4 generates unit width 5 for output image data.

FIG. 3 shows a case when unit width 10 of input image data is smaller than unit width 5 for output image data. Input image data has a value of unit width 10.

Per-unit offset data generator 2 adds white data to input image data by a number of unit widths shown as:

unit minus width 11 in left-hand side and

unit minus width 12 in right-hand side,

both provided by offset unit setup section 3.

Therefore, output of image data having unit width 13, provided by output unit width setup section 4, generates unit width 5 for output image data.

FIG. 4 shows a configuration of pixel, having 4 bits data. FIG. 5 shows a configuration of unit consisted of 2 pixel 14, having 8 bits data. An image data is output as a parallel data of bit width of unit 15.

FIG. 8 shows a flowchart of operation in each line of input image data in per-unit offset data generator 2 used in the second preferred embodiment of the present invention.

First, per-unit offset data generator 2 skips units of image data by a number of left-hand side offset unit plus width provided by offset unit setup section 3 (step 150).

Next, white data are generated by a number of left-hand side offset unit minus width provided by offset unit setup section 3 (step 151).

Next, image data is output by a number of unit width provided by output unit width setup section 4 (step 152).

Moreover, white data are generated by a number of right-hand side unit minus width provided by offset unit setup section 3 (step 153).

Additionally, units of input image data are skipped by a number of right-hand side offset unit plus width provided by offset unit setup section 3 (step 154).

Each line of input image data is processed, as mentioned above, to generate output image in per-unit offset data generator.

Finally, FIG. 9 shows an image data structure generated by per-unit offset data generator 2 in output unit width setup section 4. Unit masking section 17 provides left end unit 18 with left side masking output value, and right end unit 19 with right side masking output value (step 155).

Additionally, unit value generated by per-unit offset data generator is sent to other units. Both left end mask and right end mask have an identical mask value of unit 15, or a data of 8 bits.

Each line of input image data is thus processed to generate output image data. The image processing using apparatus disclosed in the second preferred embodiment of the present invention is carried out as mentioned above.

As mentioned above, the image processing apparatus disclosed in the present invention can perform speedy processing easily, since

(a) an offset value is set in unit, or per-unit, consisted of a plurality of pixels,

(b) the per-unit offset data generator performs offset processing in the unit value, and

(c) the per-unit offset data generator operates in unit.

Moreover, the apparatus can provide output image with an offset data controlling in each pixel or bit of input image data, due to a unit masking section to provide each bit of data in unit, sent from per-unit offset data generator, with a mask.

What is claimed is:

1. An image processing apparatus comprising:
(a) an offset unit setup section to provide an input image data with both right hand side and left hand side offset width in units of a plurality of pixels;
(b) an output unit width setup section to provide with an output image width in units of a plurality of pixels; and
(c) a per-unit offset data generator to generate an output image using an output of the offset unit setup section, an output of the output unit width setup section, and the input image data.

2. A method of image processing comprising the steps of:
(a) providing an input image data with a setting for both right hand side and left hand side offset widths in units of a plurality of pixels;
(b) providing with an output image width in units of a plurality of pixels; and
(c) generating offset image using an output of an offset unit setup section, an output of an output unit width setup section, and the input image data.

3. An image processing apparatus comprising:
(a) an offset unit setup section to provide an input image data with both right hand side and left hand side offset width in units of a plurality of pixels;
(b) an output unit width setup section to provide with an output image width in units of a plurality of pixels;
(c) a per-unit offset data generator to generate an output image using an output of the offset unit setup section, an output of the output unit width setup section, and the input image data; and
(d) a unit masking section to provide output of per-unit offset data generator with masking in each pixel or bit of a unit consisted of a plurality of pixels.

4. A method of image processing comprising the steps of:
(a) providing an input image data with a setting for both right hand side and left hand side offset widths in units of a plurality of pixels;
(b) providing with output image width in units of a plurality of pixels;
(c) generating an output image using an output of an offset unit setup section, an output of an output unit width setup section, and the input image data; and
(d) providing the output image with masking in each pixel or bit of a unit consisted of a plurality of pixels, to generate an offset image output.
